(19) United States
(12) Patent Application Publication
(10) Pub. No.: US 2019/0091596 A1
(43) Pub. Date: Mar. 28, 2019

(54) TWO-SIDED GRID WITH ELECTRICALLY CONDUCTIVE CONNECTIONS FOR A SNAP-TOGETHER ELECTRONIC TOY SET

(71) Applicant: Elenco Electronics, Inc., Wheeling, IL (US)

(72) Inventors: Gerald Joseph Cecchin, Buffalo Grove, IL (US); Marc C. Lehner, Glenview, IL (US); Alexander R. Matz, Wheeling, IL (US)

(21) Appl. No.: 15/716,235

(22) Filed: Sep. 26, 2017

(51) Int. Cl. A63H 33/04; H01R 9/28; H01R 9/16; A63H 33/10; A63H 5/00; A63H 17/00

(52) U.S. Cl. CPC A63H 33/042; H01R 9/28; H01R 9/16; A63H 17/002; A63H 5/00; A63H 33/044; A63H 33/101

(57) ABSTRACT

A grid for a snap-together electronic toy set is disclosed. The grid includes: a planar, non-conductive member; a plurality of spaced-apart, non-conductive snap-fittings; at least one first electrically conductive snap-fitting; and at least one second electrically conductive snap-fitting. The planar, non-conductive member includes first and second opposed surfaces. The plurality of spaced-apart, non-conductive snap-fittings are connected to the first opposed surface. The at least one first electrically conductive snap-fitting is connected to the first opposed surface in spaced-apart relation to the plurality of spaced-apart, non-conductive snap-fittings. The at least one second electrically conductive snap-fitting is connected to the second opposed surface. The at least one second electrically conductive snap-fitting is electrically conductively connected to the at least one first electrically conductive snap-fitting.

### FIELD OF THE DISCLOSURE

The disclosure relates to the use of a two-sided, electrically conductive grid for a snap-together electronic toy set which may comprise an educational toy set.

### BACKGROUND

Snap-together electronic toy sets, such as educational toy sets, typically utilize a base surface which contains snap-fittings on only one surface. The snap-fittings are used to mount electronic components of the electronic toy set to the base surface in order to form a complete electrical circuit. The options for connecting electronic components to the base surface are limited as only one surface of the base surface is accessible and configured to be snap-fittingly connected to the electronic components.

A grid for a snap-together electronic toy set is needed to allow electronic components to be electrically connected to multiple sides of the grid in order to provide for more variety and complexity in what can be built using a snap-together electronic toy set.

### SUMMARY

In one embodiment, a grid for a snap-together electronic toy set is disclosed. The grid includes: a planar, non-conductive member; a plurality of spaced-apart, non-conductive snap-fittings; at least one first electrically conductive snap-fitting; and at least one second electrically conductive snap-fitting. The planar, non-conductive member includes first and second opposed surfaces. The plurality of spaced-apart, non-conductive snap-fittings are connected to the first opposed surface. The at least one first electrically conductive snap-fitting is connected to the first opposed surface in spaced-apart relation to the plurality of spaced-apart, non-conductive snap-fittings. The at least one second electrically conductive snap-fitting is connected to the second opposed surface. The at least one second electrically conductive snap-fitting is electrically conductively connected to the at least one first electrically conductive snap-fitting.

In another embodiment, a snap-together electronic toy set is disclosed. The snap-together electronic toy set includes a grid, at least one power source, and at least one powered component. The grid includes: a planar, non-conductive member; a plurality of spaced-apart, non-conductive snap-fittings; at least one first electrically conductive snap-fitting; and at least one second electrically conductive snap-fitting. The planar, non-conductive member includes first and second opposed surfaces. The plurality of spaced-apart, non-conductive snap-fittings are connected to the first opposed surface. The at least one first electrically conductive snap-fitting is connected to the first opposed surface in spaced-apart relation to the plurality of spaced-apart, non-conductive snap-fittings. The at least one second electrically conductive snap-fitting is connected to the second opposed surface. The at least one second electrically conductive snap-fitting is electrically conductively connected to the at least one first electrically conductive snap-fitting. The at least one power source is electrically connected to the at least one powered component through the at least one first electrically conductive snap-fitting and the at least one second electrically conductive snap-fitting.

In still another embodiment, a method of assembling a snap-together electronic toy set is disclosed. In one step, at least one power source or at least one powered component is snap-fittingly connected to a grid. The grid includes: a planar, non-conductive member; a plurality of spaced-apart, non-conductive snap-fittings; at least one first electrically conductive snap-fitting; and at least one second electrically conductive snap-fitting. The planar, non-conductive member includes first and second opposed surfaces. The plurality of spaced-apart, non-conductive snap-fittings are connected to the first opposed surface. The at least one first electrically conductive snap-fitting is connected to the first opposed surface in spaced-apart relation to the plurality of spaced-apart, non-conductive snap-fittings. The at least one second electrically conductive snap-fitting is connected to the second opposed surface. The at least one second electrically conductive snap-fitting is electrically conductively connected to the at least one first electrically conductive snap-fitting. In another step, the at least one power source is electrically connected, through the at least one first electrically conductive snap-fitting and the at least one second electrically conductive snap-fitting, to the at least one powered component.

The scope of the present disclosure is defined solely by the appended claims and is not affected by the statements within this summary.

### BRIEF DESCRIPTION OF THE DRAWINGS

The disclosure can be better understood with reference to the following drawings and description. The components in the figures are not necessarily to scale, emphasis instead being placed upon illustrating the principles of the disclosure.

FIG. 1 illustrates a front perspective view of one embodiment of a snap-together electronic toy set;

FIGS. 2 and 3 illustrate back opposite side perspective views of the snap-together electronic toy set of FIG. 1;

FIG. 4 illustrates a front partial perspective view of the snap-together electronic toy set of FIG. 1;

FIG. 5 illustrates a side view of a snap-fitting of grids of the snap-together electronic toy set of FIG. 1;

FIG. 6 illustrates a top view of another type of snap-fitting that may be utilized for the grids of the snap-together electronic toy set of FIG. 1;

FIG. 7 illustrates a top perspective view of one of the grids of the electronic toy set of FIG. 1 with electrically conductive devices removed from spaced-apart holes of the grid;

FIG. 8 illustrates a cross-sectional view through line 8-8 of the snap-together electronic toy set of FIG. 1;

FIG. 9 illustrates a top perspective view of one embodiment of a snap-together electronic toy set comprising a vehicle; and

FIG. 10 illustrates one embodiment of a flowchart for a method of assembling a snap-together electronic toy set.

### DETAILED DESCRIPTION

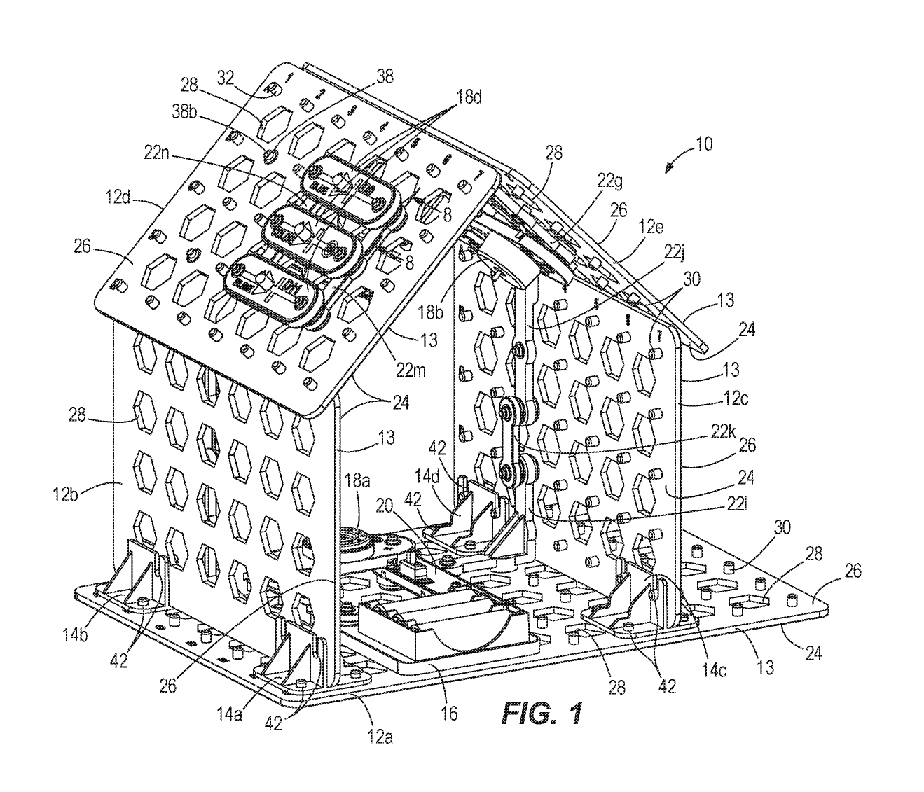

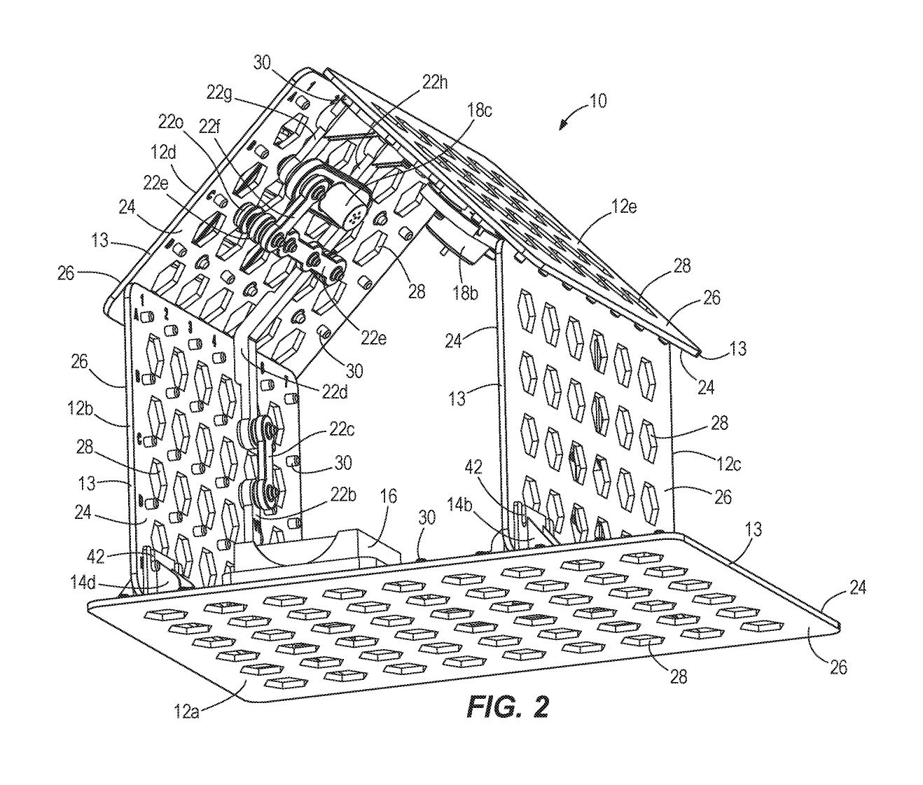

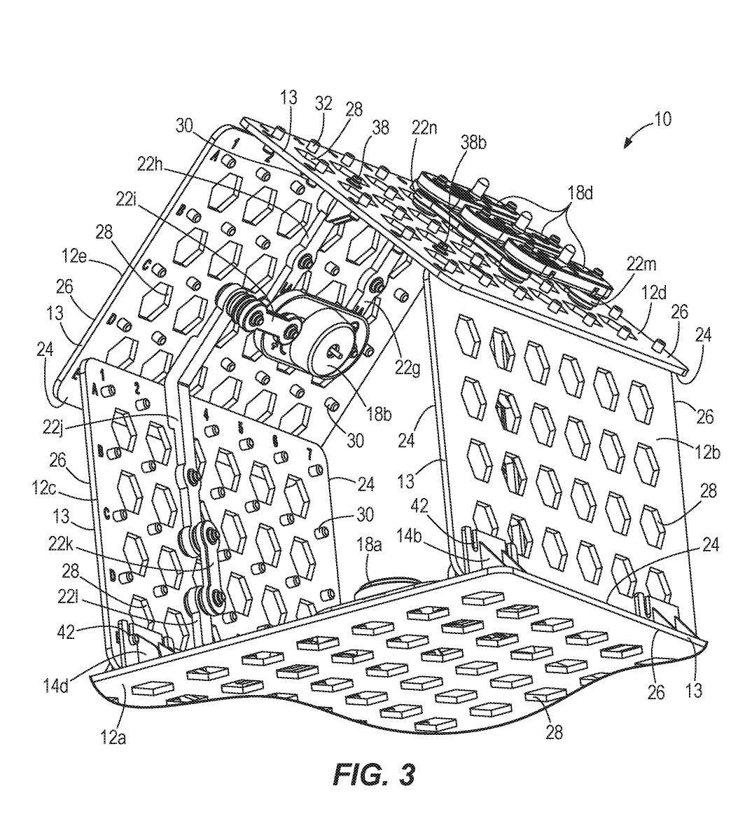

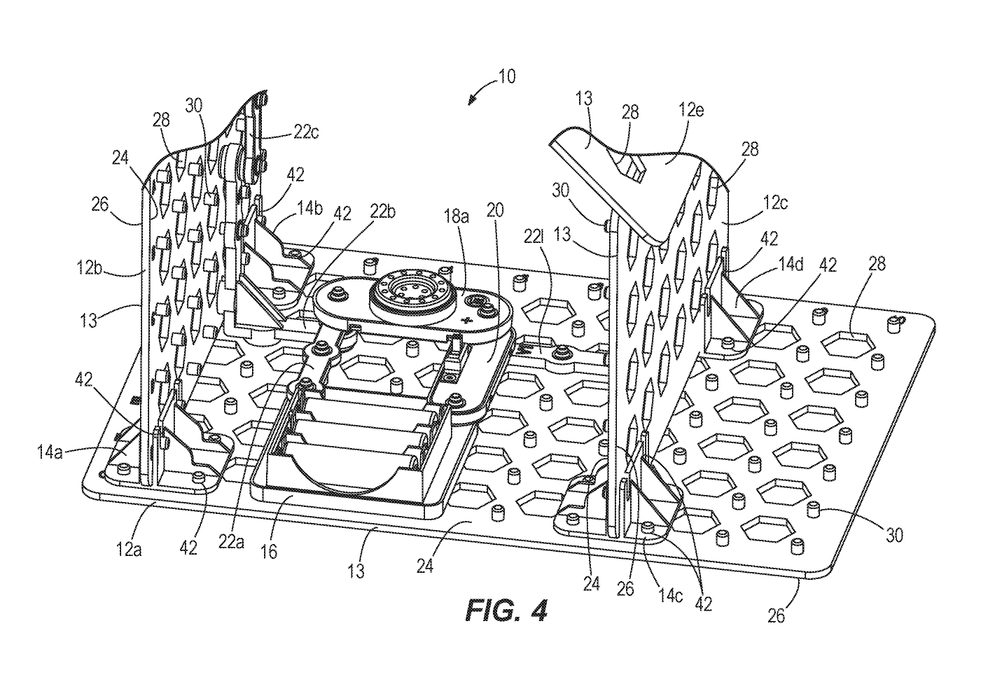

FIG. 1 illustrates a front perspective view of one embodiment of a snap-together electronic toy set 10. FIGS. 2 and 3 illustrate back opposite side perspective views of the snap-together electronic toy set 10 of FIG. 1. FIG. 4 illustrates a front partial perspective view of the snap-together electronic toy set 10 of FIG. 1.

As shown collectively in FIGS. 1-4, the snap-together electronic toy set 10, which may comprise an education toy set to assist children in building electronic circuits, comprises a toy home. However, in other embodiments the snap-together electronic toy set 10 may comprise any type of structure or vehicle. For purposes of this disclosure, the term “snap-together”, “snap-fit”, or “snap-fittingly” is defined as interlocking-components which are snapped together to be held in place as known in the art. This includes all variations in snap-fits including cantilever, torsional, annular, and all other types of snap-fits known to those of ordinary skill in the art. One typical snap-fit comprises interlocking female and male members which are configured to snap-together using a groove of the male member and a spring of the female member. However, in other embodiments the snap-fit of this disclosure may comprise any type of snap-fit known to those of ordinary skill in the art.

The electronic toy set 10 of FIGS. 1-4 comprises: grids 12a, 12b, 12c, 12d, and 12e; support members 14a, 14b, 14c, 14d; power source 16; powered components 18a, 18b, 18c, and 18d; electrical component 20; and connecting members 22a, 22b, 22c, 22d, 22e, 22f, 22g, 22h, 22i, 22j, 22k, 22l, 22m, 22n, and 22o. Grids 12a-12e each comprise a planar, non-conductive member 13 comprising opposed surfaces 24 and 26. Grids 12a-12e each further comprise a plurality of spaced-apart holes 28 extending between opposed surfaces 24 and 26. The holes 28 may be used to loop wires through the holes 28 or to attach varying components to or though the holes 28.

Opposed surface 24 of each of grids 12a-12e comprises a plurality of spaced-apart, non-conductive snap-fittings 30 connected to the opposed surface 24. Opposed surface 26 of each of grids 12a-12c and 12e does not contain any snap-fittings. Opposed surface 26 of grid 12d also comprises a plurality of spaced-apart, non-conductive snap-fittings 32 connected to the opposed surface 26. In one embodiment of grid 12d, the plurality of spaced-apart, non-conductive snap-fittings 30 connected to the opposed surface 24 and the plurality of spaced-apart, non-conductive snap-fittings 32 connected to the opposed surface 26 may comprise separate parts. In another embodiment of grid 12d, the plurality of spaced-apart, non-conductive snap-fittings 30 connected to the opposed surface 24 and the plurality of spaced-apart, non-conductive snap-fittings 32 connected to the opposed surface 26 may comprise the same part. In still other embodiments of grid 12d, only one of the opposed surfaces 24 and 26 may contain a plurality of spaced-apart, non-conductive snap fittings.

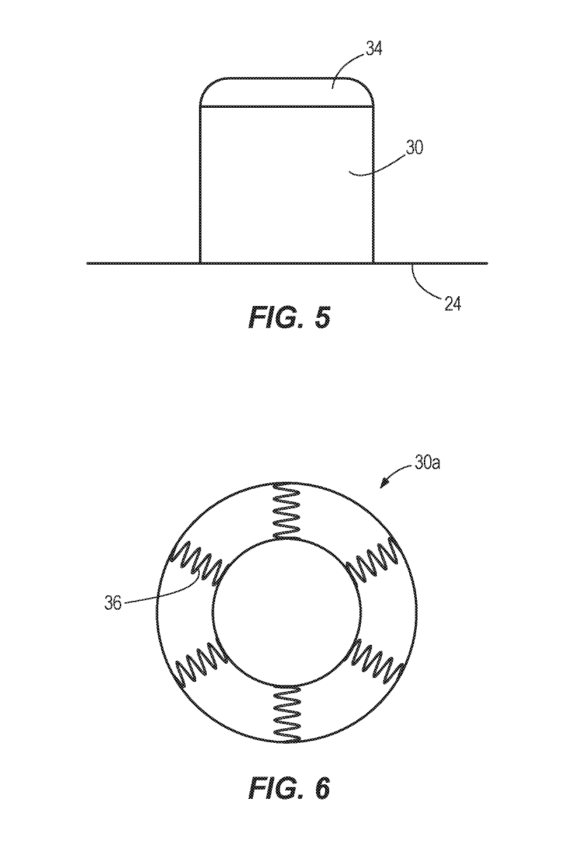

The plurality of spaced-apart, non-conductive snap-fittings 30 of opposed surface 24 of grids 12a-12e and the plurality of spaced-apart, non-conductive snap-fittings 32 of opposed surface 26 of grid 12d comprise male snap-fittings. FIG. 5 illustrates a side view of one of the spaced-apart, non-conductive snap-fittings 30 of opposed surface 24 of grids 12a-12e. All of the spaced-apart, non-conductive snap-fittings 30 of opposed surface 24 of grids 12a-12e are identical. As shown in FIG. 5, each spaced-apart, non-conductive snap-fitting 30 comprises a groove 34. Each spaced-apart, non-conductive snap-fitting 32 of grid 12d may be identical to the spaced-apart, non-conductive snap-fitting 30 of FIG. 5. However, in other embodiments the plurality of spaced-apart, non-conductive snap-fittings 30 and 32 may vary in type, shape, size, configuration, or orientation.

For instance, as shown in FIG. 6 which illustrates a top view of another type of snap-fitting 30a, in another embodiment each of the plurality of spaced-apart, non-conductive snap-fittings 30 of grids 12a-12e and each of the spaced-apart, non-conductive snap-fittings 32 of grid 12d may comprise a female snap-fitting 30a having one or more internal springs 36 to assist with snap-fitting. In still other embodiments, the plurality of spaced-apart, non-conductive snap-fittings 30 and 32 may further vary in type, shape, size, configuration, or orientation.

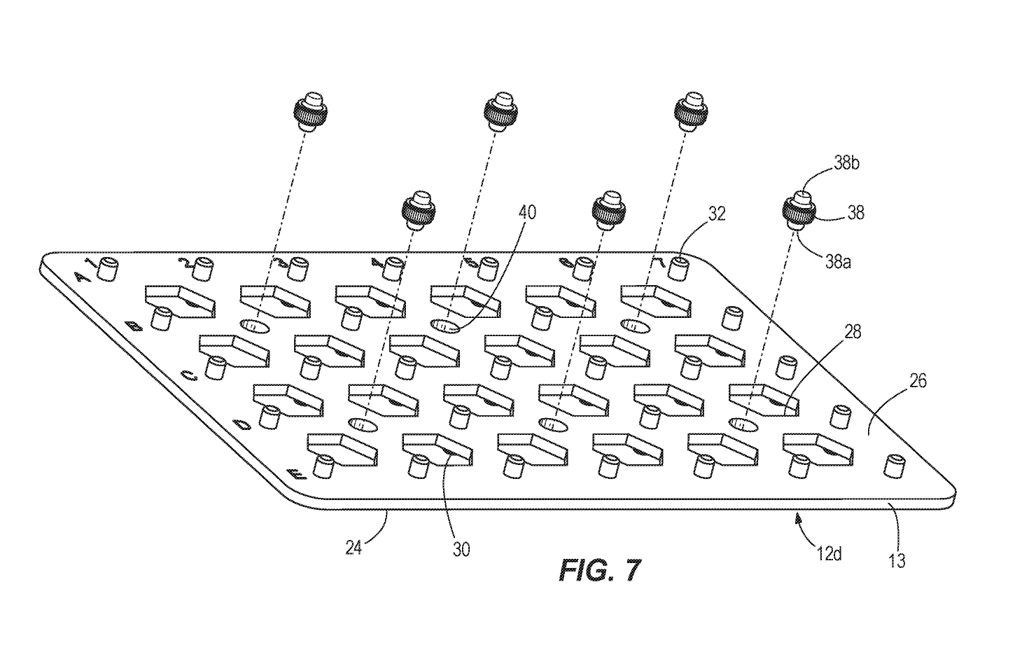

FIG. 7 illustrates a top perspective view of grid 12d with electrically conductive devices 38 removed from spaced-apart holes 40 of the grid 12d. The spaced-apart holes 40 extend between the opposed surfaces 24 and 26 in spaced-apart relation to the plurality of spaced-apart, non-conductive snap-fittings 30 and 32 connected to the opposed surfaces 24 and 26, and in spaced-apart relation to the plurality of holes 28 extending between the opposed surfaces 24 and 26. Each electrically conductive device 38 comprises a first electrically conductive snap-fitting 38a at one end and a second electrically conductive snap-fitting 38b at an opposed end which is electrically connected to the first electrically conductive snap-fitting 38a. The first and second electrically conductive snap-fittings 38a and 38b may comprise the same part. In other embodiments, the first and second electrically conductive snap-fittings 38a and 38b may comprise separate parts. When the electrically conductive devices 38 are installed in the spaced-apart holes 40 each of their first electrically conductive snap-fittings 38a are connected to the first opposed surface 24, and each of their second electrically conductive snap-fittings 38b are connected to the second opposed surface 26.

As shown collectively in FIGS. 1-4, support members 14a-14d connect grids 12a-12c together so that grids 12b and 12c are disposed perpendicularly to grid 12a. Grids 12a and 12b form the side walls and grid 12c forms the floor of the electronic toy set 10. The support members 14a-14d comprise holes 42 which mate to the spaced-apart, non-conductive snap-fittings 30 of the grids 12a-12c thereby locking the support members 14a-14d to the grids 12a-12c which correspondingly secures the grids 12a-12c to one another. The holes 42 may comprise snap-fittings such as springs to snap-fittingly mate to the groove 34 of each spaced-apart, non-conductive snap-fitting 30. In other embodiments, the holes 42 may comprise any type of snap-fitting to snap-fittingly mate to the spaced-apart, non-conductive snap-fittings 30. In still other embodiments, the holes 42 may be attached to the spaced-apart, non-conductive snap-fittings 30 using a non-snap-fitting attachment.

Grids 12d and 12e are disposed at a non-parallel angle to grids 12b and 12c in order to form a slanted roof of the electronic toy set 10. Grids 12d and 12e are attached to one-another and to grids 12b and 12c respectively through connecting members 22d, 22g, 22h, and 22j which are angled and snap-fittingly mated to the grids 12b-12e.

Power source 16 is attached to grid 12a using the spaced-apart, non-conductive snap-fittings 30 of grid 12a which snap-fittingly mate with holes (not shown) of power source 16. For ease of description, it is noted that throughout this disclosure whenever the term “snap-fit” is used that there are two interlocking snap-fitting mating parts (such as male and female snap-fittingly mated parts or other types of snap-fitting mating parts as known to those of ordinary skill in the art) connecting the components that are being snap-fittingly attached to one another. Power source 16 comprises a battery power source. In other embodiments, the power source 16 may comprise: a battery, a solar panel, an adapter, a generator, or another electrical power source. In still other embodiments, the power source 16 may vary in type or number.

Connecting member 22a is snap-fittingly attached between the power source 16 and the powered component 18a to electrically connect the powered component 18a to the power source 16 through an electrical wire of the connecting member 22a. It is noted that all of the connecting members disclosed herein contain an electrical wire and are electrically conductive. The powered component 18a comprises a sound module. In other embodiments, the powered component 18a may comprise: a capacitor, a resistor, a diode, an inductor, a transistor, a semiconductor, a triode, a motor, a fan, a sound emitter, a speaker, a buzzer, a bell, an alarm, a microphone, a light, a switch, an integrated circuit, a computer chip, an amplifier, a modulator, a computer, a computer interface, a telephone interface, a motion device, a display, a visual device, an audio device, a communication device, or another type of electrically powered component. The powered component 18a is electrically powered by the electricity delivered from the power source 16.

Electrical component 20 is snap-fittingly attached between the power source 16 and the powered component 18a to electrically connect the electrical component 20 to the power source 16 and the powered component 18a. The electrical component 20 comprises a switch. In other embodiments, the electrical component 20 may comprise: a capacitor, a resistor, a diode, an inductor, a transistor, a semiconductor, a triode, a motor, a fan, a sound emitter, a speaker, a buzzer, a bell, an alarm, a microphone, a light, a switch, an integrated circuit, a computer chip, an amplifier, a modulator, a computer, a computer interface, a telephone interface, a motion device, a display, a visual device, an audio device, a communication device, or another type of electrical component. The electrical component 20 is electrically powered by the electricity delivered from the power source 16.

Powered component 18a is snap-fittingly attached between the connecting member 22a and the electrical component 20 to electrically connect the powered component 18a between the connecting member 22a and the electrical component 20.

Connecting member 22b is snap-fittingly attached to and between grids 12a and 12b using their non-conductive snap-fittings 30. Connecting member 22b is also snap-fittingly attached between connecting members 22a and 22c to electrically connect connecting member 22a to connecting member 22c. It is noted that connecting member 22b is disposed at a right angle to allow securement to both of grids 12a and 12b.

Connecting member 22c is snap-fittingly attached between connecting members 22b and 22d to electrically connect connecting member 22b to connecting member 22d.

Connecting member 22d, which is angled, is snap-fittingly attached to and between grids 12b and 12d using the non-conductive snap-fittings 30 of grid 12b and the first electrically conductive snap-fitting 38a of grid 12d. Connecting member 22d is also snap-fittingly attached to and between connecting members 22c and 22e to electrically connect connecting member 22c to connecting member 22e.

Connecting member 22e is snap-fittingly attached to and between connecting members 22d and 22f to electrically connect connecting member 22d to connecting member 22f. Connecting member 22e is snap-fittingly attached to connecting member 22o which is snap-fittingly attached to grid 12d using the first electrically conductive snap-fittings 38a of grid 12d.

Connecting member 22f is snap-fittingly attached to and between connecting member 22e and powered component 18c to electrically connect connecting member 22e to powered component 18c. Powered component 18c comprises a lamp. In other embodiments, the powered component 18c may comprise: a capacitor, a resistor, a diode, an inductor, a transistor, a semiconductor, a triode, a motor, a fan, a sound emitter, a speaker, a buzzer, a bell, an alarm, a microphone, a light, a switch, an integrated circuit, a computer chip, an amplifier, a modulator, a computer, a computer interface, a telephone interface, a motion device, a display, a visual device, an audio device, a communication device, or another type of powered component. The powered component 18c is electrically powered by the electricity delivered from the power source 16.

Connecting member 22m is snap-fittingly attached to grid 12d using the second electrically conductive snap-fittings 38b of grid 12d. As previously discussed, the second electrically conductive snap-fittings 38b of opposed side 26 of grid 12d are electrically connected to the first electrically conductive snap-fittings 38a of opposed side 24 of grid 12d. In such manner, connecting member 22m is electrically connected to connecting member 22g, powered component 18c, and connecting member 22f through the electrically connected first and second electrically conductive snap-fittings 38a and 38b of opposed sides 24 and 26 of grid 12d.

Connecting member 22n is snap-fittingly attached to grid 12d using the second electrically conductive snap-fittings 38b of grid 12d. As previously discussed, the second electrically conductive snap-fittings 38b of opposed side 26 of grid 12d are electrically connected to the first electrically conductive snap-fittings 38a of opposed side 24 of grid 12d. In such manner, connecting member 22n is electrically connected to connecting member 22h and powered component 18c through the electrically connected first and second electrically conductive snap-fittings 38a and 38b of opposed sides 24 and 26 of grid 12d.

Powered components 18d are snap-fittingly attached to connecting members 22m and 22n to electrically connect powered components 18d to connecting members 22m and 22n. Powered components 18d comprise light emitting diodes (LED's). In other embodiments, the powered components 18d may comprise: a capacitor, a resistor, a diode, an inductor, a transistor, a semiconductor, a triode, a motor, a fan, a sound emitter, a speaker, a buzzer, a bell, an alarm, a microphone, a light, a switch, an integrated circuit, a computer chip, an amplifier, a modulator, a computer, a computer interface, a telephone interface, a motion device, a display, a visual device, an audio device, a communication device, or another type of electrically powered component. The powered components 18d are electrically powered by the electricity delivered from the power source 16.

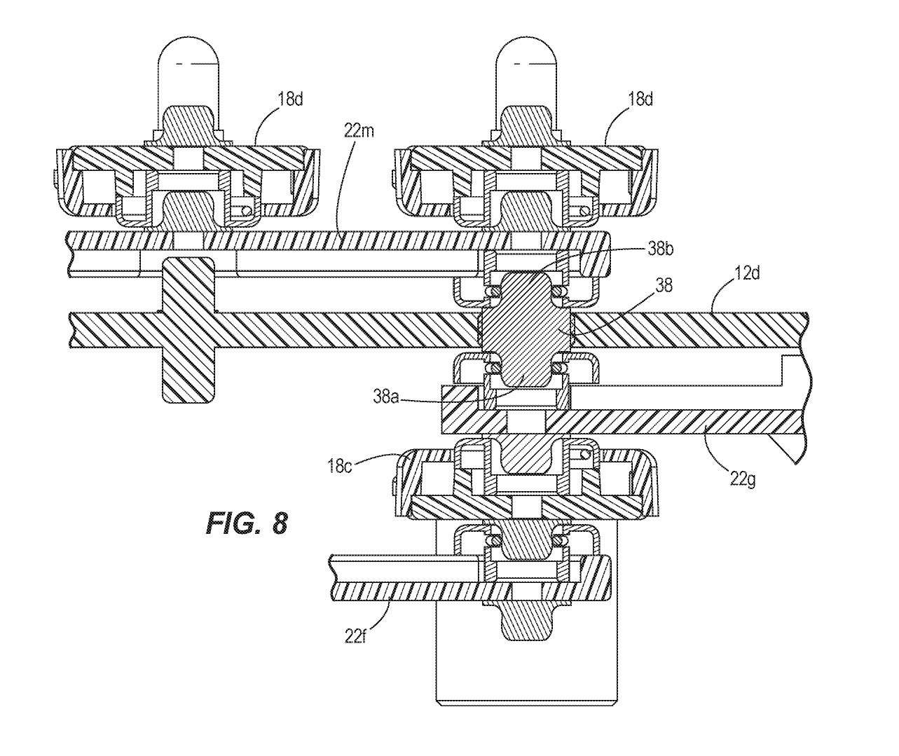

FIG. 8 illustrates a cross-sectional view through line 8-8 of FIG. 1. As shown in FIG. 8, first electrically conductive snap-fitting 38a of electrically conductive device 38 connected to opposed side 24 of grid 12d is snap-fittingly connected to connecting member 22g which is snap-fittingly connected to powered component 18c which is snap-fittingly connected to connecting member 22f Second electrically conductive snap-fitting 38b of electrically conductive device 38 connected to opposed side 26 of grid 12d is snap-fittingly connected to connecting member 22m which is snap-fittingly connected to powered components 18d on opposed side 26 of grid 12d.

Referring back to FIGS. 1-4 collectively, connecting member 22g, which is angled, is snap-fittingly attached to grids 12d and 12e using the first electrically conductive snap-fittings 38a of grid 12d and the non-conductive snap-fittings 30 of grid 12e. Connecting member 22g is also snap-fittingly attached to and between powered component 18c and electrical powered 18b to electrically connect powered components 18c and 18b. Powered component 18b comprises a motor which rotate a fan or move another object. In other embodiments, the powered component 18b may comprise: a capacitor, a resistor, a diode, an inductor, a transistor, a semiconductor, a triode, a motor, a fan, a sound emitter, a speaker, a buzzer, a bell, an alarm, a microphone, a light, a switch, an integrated circuit, a computer chip, an amplifier, a modulator, a computer, a computer interface, a telephone interface, a motion device, a display, a visual device, an audio device, a communication device, or another type of powered component. The powered component 18b is electrically powered by the electricity delivered from the power source 16.

Connecting member 22h, which is angled, is snap-fittingly attached to grids 12d and 12e using the first electrically conductive snap-fittings 38a of grid 12d and the non-conductive snap fittings 30 of grid 12e. Connecting member 22h is also snap-fittingly attached to and between powered component 18c and powered component 18b to electrically connect powered components 18c and 18b.

Connecting member 22i is snap-fittingly attached to and between powered component 18b and connecting member 22j to electrically connect powered component 18b to connecting member 22j.

Connecting member 22j, which is angled, is snap-fittingly attached to grids 12e and 12c using their non-conductive snap-fittings 30. Connecting member 22j is also snap-fittingly attached to and between connecting member 22i and connecting member 22k to electrically connect connecting members 22i and 22k.

Connecting member 22k is snap-fittingly attached to and between connecting member 22j and connecting member 22l to electrically connect connecting member 22j to connecting member 22l.

Connecting member 22l, which is perpendicular, is snap-fittingly attached to grids 12a and 12c using the non-conductive snap-fittings 30 of grids 12a and 12c. Connecting member 22l is also snap-fittingly attached to and between connecting member 22k and powered component 18a to electrically connect connecting member 22k and powered component 18a.

In such manner, using the connecting members 22a-22o and the first and second electrically conductive snap-fittings 38a and 38b, a completed electrical circuit is formed so that the powered components 18a-18d and the electrical component 20 are electrically powered by the power source 16.

In other embodiments, the electronic toy set 10 may vary in type, size, components, configuration, and/or orientation. For instance, in other embodiments the electronic toy set 10 of FIGS. 1-4 may use any number, type, location, configuration, and orientation of grids, support members, power sources, powered components, electrical components, connecting members, or other types of components in varying locations relative to one another.

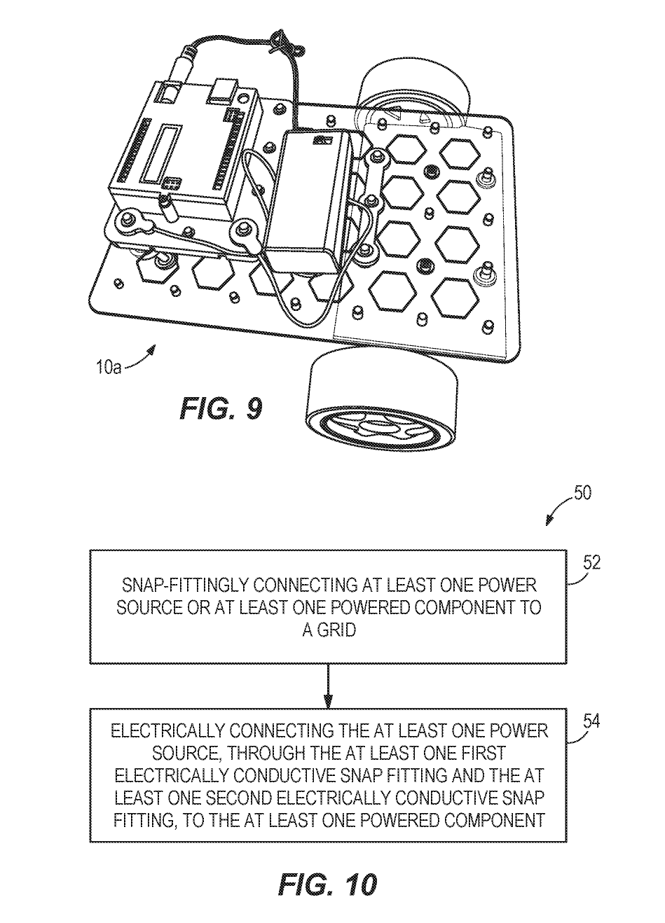

FIG. 9 illustrates a top perspective view of one embodiment of an electronic toy set 10a comprising a vehicle. The instant disclosure may be used to form the electronic toy set 10a comprising the vehicle of FIG. 9. For purposes of this disclosure, the term “vehicle” is defined as any moving structure which is configured to move a person or animal including but not limited to land-operating vehicles, water-operating vehicles, air-operating vehicles, and space-operating vehicles. In still other embodiments, the instant disclosure may be used to build any type of structure.

FIG. 10 illustrates one embodiment of a flowchart for a method 50 of assembling a snap-together electronic toy set. The method 50 may utilize any of the embodiments of the instant disclosure. In step 52, at least one power source or at least one powered component is snap-fittingly connected to a grid. The grid comprises a planar, non-conductive member comprising first and second opposed surfaces. The grid further comprises a plurality of spaced-apart, non-conductive snap-fittings connected to the first opposed surface. The grid also comprises at least one first electrically conductive snap-fitting connected to the first opposed surface in spaced-apart relation to the plurality of spaced-apart, non-conductive snap-fittings. The grid additionally comprises at least one second electrically conductive snap-fitting connected to the second opposed surface. The at least one second electrically conductive snap-fitting is electrically conductively connected to the at least one first electrically conductive snap-fitting. In step 54, the at least one power source is electrically connected, through the at least one first electrically conductive snap-fitting and the at least one second electrically conductive snap-fitting, to the at least one powered component.

An optional step of the method 50 comprises electrically connecting one or more electronic components between and to the at least one power source and the at least one power source. Another optional step of the method 50 comprises electrically connecting, using at least one connecting member, the at least one power source to the at least one powered component. Still another optional step of the method 50 comprises connecting at least a second grid to the grid, wherein the second grid is planar and comprises a second plurality of non-conductive snap-fittings disposed on only one side of the second grid. Yet another optional step of the method 50 comprises snap-fittingly connecting the at least one power source or the at least one powered component to the grid or to the second grid. Another optional step of the method 50 comprises building a toy house or a toy vehicle using the grid. In other embodiments, one or more steps of the method 50 may be modified in substance or in order, one or more steps of the method 50 may not be followed, or one or more additional steps may be added to the method 50.

One or more embodiments of the disclosure may overcome one or more drawbacks of the prior snap-together electronic toy sets by providing one or more grids containing electrically conductive snap-fittings on multiple sides of the grid to allow a wider variety and complexity of the components which can be electrically attached to the snap-together electronic toy set.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true scope of the subject matter described herein. Furthermore, it is to be understood that the disclosure is defined by the appended claims. Accordingly, the disclosure is not to be restricted except in light of the appended claims and their equivalents.

1. A grid for a snap-together electronic toy set comprising:
a planar, non-conductive member comprising first and second opposed surfaces;
a plurality of spaced-apart, non-conductive snap-fittings connected to the first opposed surface;
at least one first electrically conductive snap-fitting connected to the first opposed surface in spaced-apart relation to the plurality of spaced-apart, non-conductive snap-fittings; and
at least one second electrically conductive snap-fitting connected to the second opposed surface, the at least one second electrically conductive snap-fitting electrically conductively connected to the at least one first electrically conductive snap-fitting.

2. The grid of claim 1 wherein there are a plurality of the first electrically conductive snap-fitting connected to the first opposed surface in spaced-apart relation to the plurality of spaced-apart, non-conductive snap-fittings.

3. The grid of claim 1 wherein there are a plurality of the second electrically conductive snap-fitting connected to the second opposed surface.

4. The grid of claim 1 wherein there are a plurality of the first electrically conductive snap-fitting connected to the first opposed surface in spaced-apart relation to the plurality of spaced-apart, non-conductive snap-fittings, and there are a plurality of the second electrically conductive snap-fitting connected to the second opposed surface, each of the second electrically conductive snap-fittings electrically conductively connected to a respective one of the first electrically conductive snap-fittings.

5. The grid of claim 1 wherein the at least one first electrically conductive snap-fitting and the at least one second electrically conductive snap-fitting comprise opposite ends of a same part.

6. The grid of claim 1 wherein the at least one first electrically conductive snap-fitting and the at least one second electrically conductive snap-fitting comprise separate parts.

7. The grid of claim 1 wherein the planar, non-conductive member further comprises a plurality of spaced-apart holes extending in and between the first and second opposed surfaces.

8. A snap-together electronic toy set comprising:
a grid comprising: a planar, non-conductive member comprising first and second opposed surfaces; a plurality of spaced-apart, non-conductive snap-fittings connected to the first opposed surface; at least one first electrically conductive snap-fitting connected to the first opposed surface in spaced-apart relation to the plurality of spaced-apart, non-conductive snap-fittings; and at least one second electrically conductive snap-fitting connected to the second opposed surface, the at least one second electrically conductive snap-fitting electrically conductively connected to the at least one first electrically conductive snap-fitting;
at least one power source; and
at least one powered component;
wherein the at least one power source is electrically connected to the at least one powered component through the at least one first electrically conductive snap-fitting and the at least one second electrically conductive snap-fitting.

9. The snap-together electronic toy set of claim 8 wherein the at least one power source or the at least one powered component is snap-fittingly connected to the grid.

10. The snap-together electronic toy set of claim 8 comprising the at least one power source, wherein the at least one power source is selected from the group of: a battery, a solar panel, an adapter, a generator, or another electrical power source.

11. The snap-together electronic toy set of claim 8 wherein the at least one powered component is selected from the group of: a capacitor, a resistor, a diode, an inductor, a transistor, a semiconductor, a triode, a motor, a fan, a sound emitter, a speaker, a buzzer, a bell, an alarm, a microphone, a light, a switch, an integrated circuit, a computer chip, an amplifier, a modulator, a computer, a computer interface, a telephone interface, a motion device, a display, a visual device, an audio device, a communication device, and any combination thereof.

12. The snap-together electronic toy set of claim 8 further comprising one or more electronic components electrically connected between and to the at least one power source and the at least one powered component.

13. The snap-together electronic toy set of claim 12 wherein the one or more electronic components is selected from the group of: a capacitor, a resistor, a diode, an inductor, a transistor, a semiconductor, a triode, a motor, a fan, a sound emitter, a speaker, a buzzer, a bell, an alarm, a microphone, a light, a switch, an integrated circuit, a computer chip, an amplifier, a modulator, a computer, a computer interface, a telephone interface, a motion device, a display, a visual device, an audio device, a communication device, and any combination thereof.

14. The snap-together electronic toy set of claim 8 further comprising at least one connecting member electrically connecting the at least one power source to the at least one powered component.

15. The snap-together electronic toy set of claim 8 further comprising a second grid which is planar and connected to the grid, the second grid comprising a second plurality of spaced-apart, non-conductive snap-fittings disposed on only one side of the second grid.

16. The snap-together electronic toy set of claim 15 wherein the at least one power source or the at least one powered component is snap-fittingly connected to the grid or to the second grid.

17. The snap-together electronic toy set of claim 8 comprising a toy house or a toy vehicle.

18. A method of assembling a snap-together electronic toy set comprising:
snap-fittingly connecting at least one power source or at least one powered component to a grid, the grid comprising: a planar, non-conductive member comprising first and second opposed surfaces; a plurality of spaced-apart, non-conductive snap-fittings connected to the first opposed surface; at least one first electrically conductive snap-fitting connected to the first opposed surface in spaced-apart relation to the plurality of spaced-apart, non-conductive snap-fittings; and at least one second electrically conductive snap-fitting connected to the second opposed surface, the at least one second electrically conductive snap-fitting electrically conductively connected to the at least one first electrically conductive snap-fitting; and
electrically connecting, through the at least one first electrically conductive snap-fitting and the at least one second electrically conductive snap-fitting, the at least one power source to the at least one powered component.

19. The method of claim 18 further comprising electrically connecting one or more electronic components between and to the at least one power source and the at least one powered component.

20. The method of claim 18 further comprising electrically connecting, using at least one connecting member, the at least one power source to the at least one powered component.

21. The method of claim 18 further comprising connecting at least a second grid to the grid, the second grid being planar and comprising a second plurality of non-conductive snap-fittings disposed on only one side of the second grid.

22. The method of claim 18 further comprising snap-fittingly connecting the at least one power source or the at least one powered component to the grid or to the second grid.

23. The method of claim 18 further comprising building a toy house or a toy vehicle using the grid.
